(19) United States
(12) Patent Application Publication
(10) Pub. No.: US 2008/0225777 A1
(43) Pub. Date: Sep. 18, 2008

(54) Method and Device for Controlling Write Power in a Recordable Optical Storage System

(75) Inventor: Tony Petrus Van Endert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,469

(22) PCT Filed: Oct. 27, 2006
(86) PCT No.: PCT/IB06/53958

§ 371 Date: May 2, 2008

(30) Foreign Application Priority Data
Nov. 4, 2005 (EP) 05110371.1

(51) Int. Cl. H04B 7/185

(52) U.S. Cl. 370/318

(57) ABSTRACT

The invention provides an optimum write power control technique for controlling the write power during write processes in recordable optical storage systems, especially in Rewritable optical systems. In an Optimum Power Calibration (OPC) procedure an optimum write power level is determined from the jitter values of recorded test marks.

The present invention relates generally to controlling the write power in recordable optical storage systems, and more specifically to a method of and a device for determination of an optimum write power for use with recordable optical storage systems and optical storage discs.

As is well known, optical discs, such as CD-R (Compact Disc-Recordable), CD-RW (Compact Disc-ReWritable), DVD-R (DVD-Recordable), DVD±R (DVD-ReWritable) and the like, are made up of an optical stack. The stack commonly consists of a polycarbonate substrate, a sensitive dye layer (for R-type discs) or phase change layer (for RW-type discs), a gold or silver alloy reflector and a protective lacquer coating. Data is written to a disc by focusing a high power radiation beam, such as a laser beam, onto the dye layer or phase change layer so as to heat an area such that the reflectivity of this area is altered. The areas form a spiral track of variable length “marks” (low reflective areas), and “lands” (highly reflective areas between the marks). The resulting pattern of the marks and lands encodes the data to be stored on the disc. Each transition between a mark area and a land area corresponds to the physical encoding of a transition in a signal representing the encoded data. For example, for CD the data is encoded according to the well-known EFM (Eight-to-Fourteen Modulation) modulation code where the marks and lands are typically 3 to 11 clock cycles in length (3T to 11T, where ‘T’ represents the data clock period).

Precise mark length is critical if data is to be represented accurately. For example, if an optical reader reads a disc with a number of 3T marks or lands that are too long, these could be misinterpreted as 4T features. This misinterpretation may result in incorrect data retrieval, and, in extreme cases, read-failure.

For this reason, it is important that optical recorders are able to monitor and maintain the quality of writing data to a disc in order to ensure the accuracy of all the mark and land lengths over the particular disc being written.

In order to achieve accurate mark/land lengths, there will be an optimum radiation recording power for the disc/recorder combination being used. The optimum radiation recording power that should be used when recording an optical disc is therefore dependent upon the actual disc, the recorder being used and, possibly, also the speed at which the recording is taking place.

This optimum radiation recording power (also referred to as optimum write power) should be determined for each recorder/disc combination at the actual recording speed, preferably before the actual recording of the data. Such determination is called an Optimum Power Control (OPC) procedure. Applying this determined optimum radiation recording power allows a given recorder to produce the correct mark/land lengths for a given disc.

Different types of OPC procedures are currently in use. For R-type discs ‘Beta’ (β) and jitter-based OPC methods are generally used, whilst for RW-type discs a ‘Gamma’ (γ) method is generally used as the OPC procedure. In the ‘Beta’ (β) OPC method the optimum radiation recording power is determined by minimizing the asymmetry of the High Frequency (HF) signal obtained from reading the marks and lands in recorded test patterns (see, for example, DVD+R, Basic Format Specification, System Description). In the ‘Gamma’ (γ) OPC method the optimum radiation recording power is determined from a modulation (m) versus write power (P) curve obtained by recording test patterns of marks at various write powers and subsequently determining the modulation of the thus recorded marks (see, for example, DVD+RW, Basic Format Specification, System Description).

The jitter-based OPC procedure is one of the most preferred methods for Recordable media. Jitter is a statistical measurement of the variation in mark or land length around a mean value for each run length, and is a generally accepted measure of timing errors that occur when a player/recorder reads data. Minimizing the jitter ensures that marks and lands with a precise mark length, respectively land length, are recorded. The jitter-based OPC method is an especially attractive OPC method because the measured jitter is directly related to the quality of the recorded marks, whereas the ‘Beta’ (β) OPC method and the ‘Gamma’ (γ) method use parameters (the asymmetry and the modulation versus write power curve, respectively) which are indirectly related to the quality of the recorded marks.

The presently used OPC methods often require information that is pre-stored on the optical disc itself. Information may be pre-stored onto a disc which provides a recorder, for example, with an indicative power level with which to begin an OPC procedure, or with a disc specific parameter to be used in the determination of the optimum radiation recording power. This information may not, however, always be correct, and can result in OPC failure.

A further disadvantage of presently used OPC procedures is the requirement for large amounts of disc area for recording test patterns in order to average out variations in the disc properties along the circumference of the disc (such as disc eccentricity for example). The large test areas that are needed detract from the space available for data storage, and the tests also take a long time to perform.

For phase change media, generally used as RW-type discs, the ‘Gamma’ (γ) method or a modified version of it, the ‘Kappa’ (κ) method, is normally used in the different optical disc standards. In the ‘Gamma’ (γ) method the optimum radiation recording power (that is, the optimum write power) is determined from a modulation (m) versus write power (P) curve (see, for example, U.S. Pat. No. 5,793,737 and WO98/28742), while in the ‘Kappa’ (κ) method this procedure is modified so as to use a modulation times write power (P*m) versus write power (P) curve (see WO02/41306).

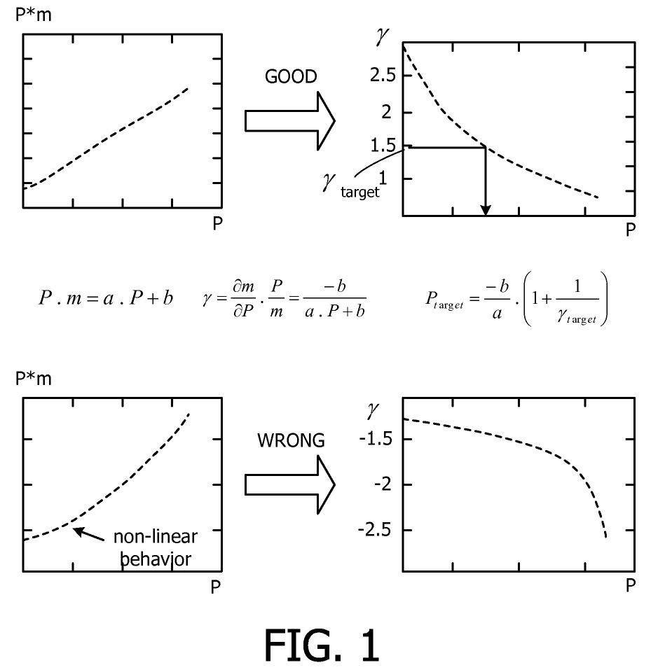

However, these γ-based methods are very sensitive for non-linearity of the modulation (m) versus write power (P) curve (or of the modulation times write power (P*m) versus write power (P) characteristics). FIG. 1 of the accompanying drawings illustrates this sensitivity. The graphs to the left in FIG. 1 illustrate such linear (upper) and non-linear (lower) behavior. The graphs to the right in FIG. 1 show the resulting good (upper) and wrong (lower) γ versus write power (P) curves from which the optimum write power is deduced (for example using the pre-stored disc specific parameter γ_{target}). It is noted that γ is the derivative of the modulation (m) over the write power (P) normalized by the write power (P) over the modulation (m). The consequence of this non-linearity is that the OPC procedure can fail, or at least results in an increase in calibration time.

Current γ-based OPC techniques make use of calibration data pre-stored on the disc itself (such as, for example, γ_{target}). Different optical standards make use of different kinds of calibration data, and this calibration data can itself lead to inaccuracy in the OPC method.

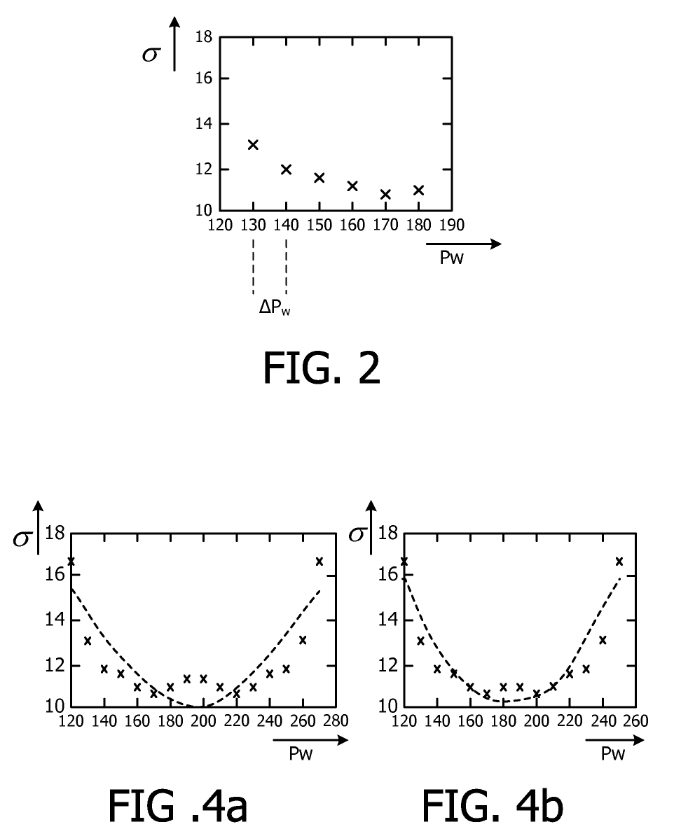

It is possible to use a technique that is based on measurement of jitter of the recorded marks versus the write power used to record these marks to improve on known γ-based OPC techniques for phase-change ReWritable media. However, such a jitter-based technique that is suitable for dye-based media (that is, Recordable media) may not be ideally suited for use with phase change media (that is, ReWritable media), since the jitter versus power curve is typically asymptotic in shape (see for example FIG. 2). Accordingly, the simple second order curve approximations used in known jitter-based techniques are not accurate for use with phase change media. However, jitter-based OPC techniques are generally space-efficient, and so it is desirable to use a jitter-based technique for phase-change media.

It is therefore an object of the present invention to provide a fast and space efficient jitter-based OPC method that can also be used in combination with phase-change (that is, ReWritable) media. Preferably such a method is also independent of information that is pre-stored on a disc.

The present invention provides an optimum write power control technique for supply of radiation power during write processes in recordable (including ReWritable) optical storage systems. Embodiments of the present invention are able to overcome the disadvantage of known OPC techniques, by fitting a second order curve to a number of measured and calculated jitter values. Such curve fitting tends to mitigate against errors occurring in the estimation of minimum jitter values. Moreover, an optimum write power level is determined that balances minimum jitter values of the recorded marks with desirably high direct overwrite (DOW) factors.

According to a first aspect of the present invention, there is provided a method for controlling the write power in a recordable optical storage system, the method comprising the steps of:

a) generating a first even number of jitter values (σ₀ . . . σ₂ₙ₋₁) corresponding to respective ones of a plurality of write power levels (P_{w,0} . . . P_{w,2n-1}), which write power levels are arranged in equal first (P_{w,0} . . . P_{w,n-1}) and second (P_{w,n} . . . P_{w,2n-1}) non-overlapping series of power levels, jitter values (σ₀ . . . σₙ₋₁) corresponding to the first series of power levels being generated from measurement of jitter values resulting from respective write processes at the write power levels concerned, and jitter values (σₙ . . . σ₂ₙ₋₁) corresponding to the second series of power levels being derived from the jitter values corresponding to the first series such that the jitter values corresponding to the second series mirror the jitter values corresponding to the first series with respect to the write power level;
b) generating curve data from the first and second series of jitter values and corresponding write power levels;
c) determining an initial minimum jitter value and corresponding write power level from the generated curve data;
d) iterating steps a) to c) to determine a further minimum jitter value and corresponding further write power level for each iteration, each iteration having one less jitter value in each series than the previous iteration, the iteration being carried out until the further minimum jitter value determined in the iteration is greater than an overall minimum jitter value by a predetermined amount or more, the overall minimum jitter value being the minimum value of the initial minimum jitter value and the further minimum jitter values determined in the previous iterations; and of
e) determining an optimum write power level from the further write power level corresponding to the further minimum jitter value that is greater than the overall minimum jitter value by a predetermined amount or more.

In a preferred embodiment the curve data generated from the first and second series of jitter values and corresponding write power levels form a second order polynomial curve.

Calculating a mirror set of jitter values from the measured jitter values (in step a) enables a curve, especially a second order polynomial curve, to be fitted to the jitter values reliably (in step b), which itself enables the optimum power level to be found reliably. This is because the sequence of jitter values (that is, the measured jitter values followed by the mirror set of jitter values) is no longer asymptotic in shape.

It is a further advantage that the technique of iterating steps a) to c) of the method, each with one fewer measured points than the previous iteration, ensures that the true minimum jitter value is found, rather than a “false” minimum value generated by a stray measurement or characteristic of the medium concerned. It is to be noted that the above method according to the invention may be used without iterating steps a) to c), which would result in a good value for the optimum power level; however the most reliable value for the optimum power level is obtained when steps a) to c) are iterated.

In an embodiment of the invention the write power levels (P_{w}) are spaced from one another by a predetermined power level step. This allows for the method to be performed relatively easily. It is noted that the OPC measurements may be performed at relatively low write power levels that do not have an effect on the direct overwrite factor of the media concerned.

In an embodiment of the invention the optimum write power level is determined (in step e) from the further write power level corresponding to the further minimum jitter value that is greater than the overall minimum jitter value by a predetermined amount or more, and from the further write power level corresponding to the further minimum jitter value determined in the previous iteration. In a preferred embodiment, the optimum write power level is determined using a linear interpolation between these two further write power levels, from the following equation:

$${P}_{WO} = {P}_{O , M} + ( \frac{{J}_{M} - ( {σ}_{min} + Δ σ )}{{J}_{M} - {J}_{M - 1}} ) \cdot ( {P}_{O , M - 1} - {P}_{O , M} )$$

where P_{WO} is the optimum write power level, Jₘ is the further minimum jitter value that is greater than the overall minimum jitter value (σₘᵢₙ) by a predetermined amount (Δσ) or more and P_{O,M} is the corresponding further write power level, and J_{M-1} is the further minimum jitter value determined in the previous iteration and P_{O,M-1} is the corresponding further write power level.

It is noted that when the write power levels are spaced from one another by a predetermined power level step ΔP_{w}, this equation reduces to:

$${P}_{WO} = {P}_{O , M} + ( \frac{{J}_{M} - ( {σ}_{min} + Δ σ )}{{J}_{M} - {J}_{M - 1}} ) \cdot Δ {P}_{w}$$

According to a further aspect of the present invention, there is provided a power controller for use in a recordable optical storage system, the controller being operable to:

a) generate a first even number of jitter values (σ₀ . . . σ₂ₙ₋₁) corresponding to respective ones of a plurality of write power levels (P_{w,0} . . . P_{w,2n-1}), which write power levels are arranged in equal first (P_{w,0} . . . P_{w,n-1}) and second (P_{w,n} . . . P_{w,2n-1}) non-overlapping series of write power levels, jitter values (σ₀ . . . σₙ₋₁) corresponding to the first series of write power levels being generated from measurement of jitter values resulting from respective write processes at the write power levels concerned, and jitter values (σₙ . . . σ₂ₙ₋₁) corresponding to the second series of write power levels being derived from the jitter values corresponding to the first series such that the jitter values corresponding to the second series mirror the jitter values corresponding to the first series with respect to the write power level;
b) generate curve data from the first and second series of jitter values and corresponding write power levels;
c) determine an initial minimum jitter value and corresponding write power level from the generated curve data;
d) iterate steps a) to c) to determine a further minimum jitter value and corresponding further write power level for each iteration, each iteration having one less jitter value in each series than the previous iteration, the iteration being carried out until the further minimum jitter value determined in the iteration is greater than an overall minimum jitter value by a predetermined amount or more, the overall minimum jitter value being the minimum value of the initial minimum jitter value and the further minimum jitter values determined in the previous iterations; and to
e) determine the optimum write power level from the further write power level corresponding to the further minimum jitter value that is greater than the overall minimum jitter value by a predetermined amount or more.

In a preferred embodiment the power controller is operable to generate, from the first and second series of jitter values and corresponding write power levels, curve data forming a second order polynomial curve.

An embodiment of the power controller according to the invention comprises, or is connected to, storage means for storing the overall minimum jitter value. Such a power controller is operable to store the initial minimum jitter value as the overall minimum jitter value in said storage means, and to, in each iteration, replace the stored overall minimum jitter value with the further minimum jitter value in the iteration step when this further minimum jitter value is found to be lower that the stored overall minimum jitter.

Another aspect of the present invention provides a recordable optical storage system that includes such a power controller. Such a power controller, and a system including the same, enables reliable Optimum Power Control (OPC) procedures for determining optimum write power levels for recording on optical media.

It is noted that the present invention provides a jitter-based OPC procedure that can be used for determining the optimum write power for recording on ReWritable optical discs as well as on Recordable optical discs. This has the additional advantage that a single OPC procedure can be used for both types of discs.

In the following the invention will be elucidated in greater detail. Embodiments of the invention will be described, by way of example only, with reference to the accompanying drawings, in which

FIG. 1 illustrates a known power control method;

FIG. 2 illustrates measured jitter samples for a method embodying the present invention;

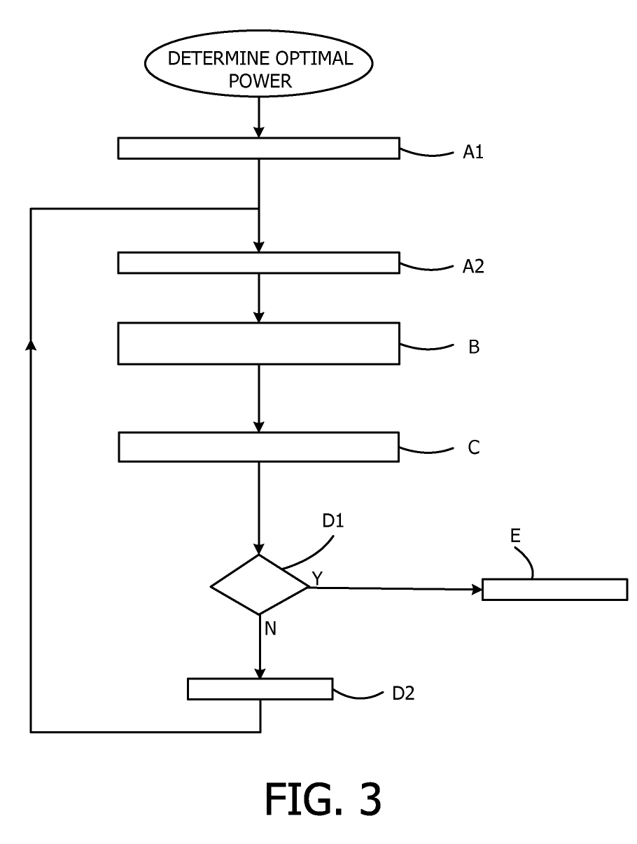

FIG. 3 illustrates steps in a method embodying the present invention;

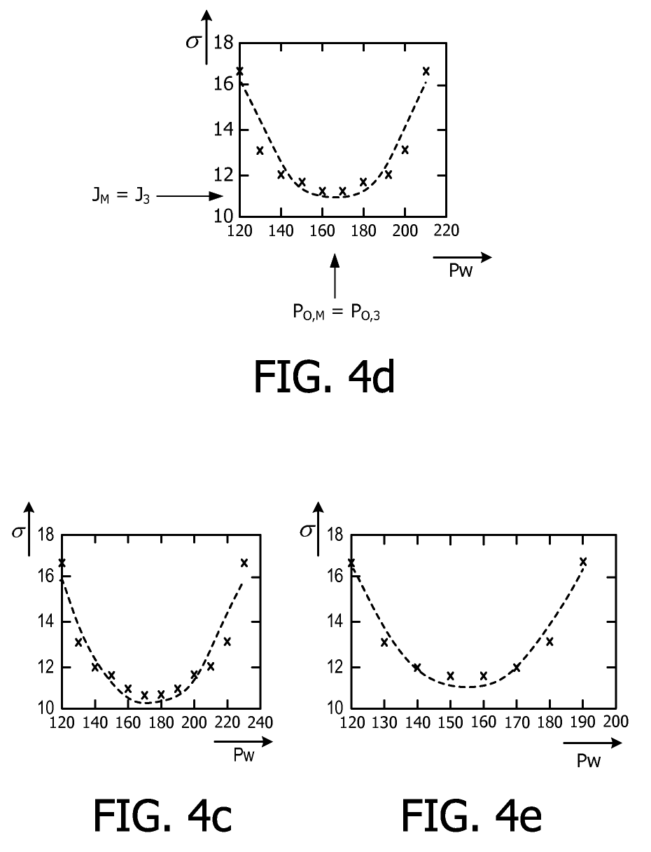

FIG. 4 (including FIGS. 4a, 4b, 4c, 4d and 4e) illustrates results of the method of FIG. 3; and

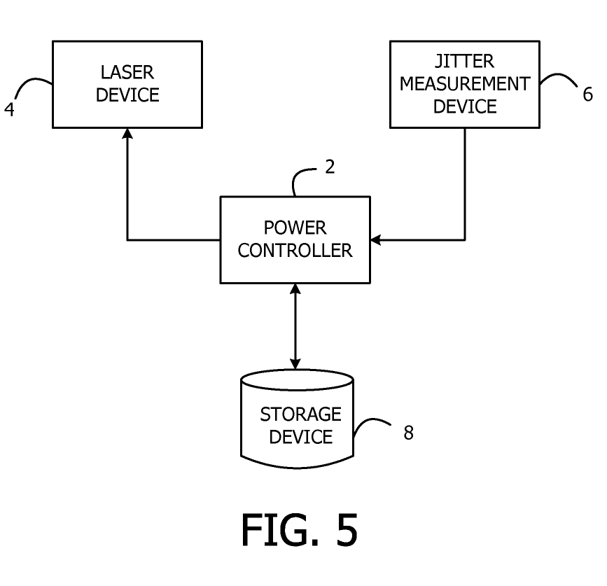

FIG. 5 illustrates a power controller according to an embodiment of the present invention in use in an optical storage system.

Embodiments of the present invention are concerned with controlling the power of a radiation beam for writing data to an optical disc. As such, embodiments of the present invention provide a technique based on measurement of jitter (a) versus power (P) characteristics of the disc on which data is to be written.

Such a technique according to the invention is suitable for application to phase change media such as those used for ReWritable media. For such media, it is desirable to set the write power level for recording marks to the optical disc as low as possible, but at the same time keep the jitter of the recorded marks below a desirably low level.

In an OPC technique embodying the present invention, a series of write procedures are undertaken at different respective write power levels (P_{w,i}), and the jitter values (σᵢ) associated with the marks recorded at these different write power levels are measured. Preferably, the jitter values of several marks recorded at a single write power level are measured in order to obtain an average (and therefore more robust) jitter value (σᵢ) for each of the respective write power levels (P_{w,i}). These initially measured jitter values (σᵢ) are used in the successive iteration steps, without the need for further write procedures.

FIG. 3 illustrates the steps in a method embodying the present invention. This method will now be described in detail with reference to FIGS. 2, 3 and 4. Initially, for a predetermined number n of sample write powers P_{w,i}, measurements are taken (step A1) of the corresponding jitter value σᵢ. A result of such a measurement is illustrated in FIG. 2. These measured jitter values σᵢ(0≦i≦n−1) are then “mirrored” (step A2) for the next n power values, as illustrated in Table 1 below. In this context, “mirroring” of the measured jitter values means that the first series of measured jitter values (σ₀ . . . σₙ₋₁), at respective spaced apart write power levels (P_{w,0} . . . P_{w,n-1}), is reflected and projected onto a second series of similarly spaced apart power levels (P_{w,n} . . . P_{w,2n-1}). The second series of power levels extends above the first series in a preferred embodiment. The second series of jitter values (σₙ . . . σ₂ₙ₋₁) mirror the measured jitter values with respect to the power level. The measured and calculated jitter (σ₀ . . . σ₂ₙ₋₁) values thereby form an even number of jitter values, effectively divided into first and second distinct non-overlapping series.

TABLE 1

| P_{w, i} | σ₁ | |
|---|---|---|
| P_{w, 0} | σ₀ | First |
| P_{w, 1} | σ₁ | series |
| . . . | . . . | |
| P_{w, n-1} | σₙ₋₁ | |
| P_{w, n} = P_{w, n-1} + ΔP_{w} | σₙ = σₙ₋₁ | Second |
| P_{w, n+1} = P_{w, n} + ΔP_{w} | σₙ₊₁ = σₙ₋₂ | series |
| . . . | . . . | |
| P_{w, 2n-1} = P_{w, 2n-2} + ΔP_{w} | σ₂ₙ₋₁ = σ₀ | |

A second order polynomial regression curve (σ=a·P_{W}²+b·P_{W}+c) is then calculated (step B) from the measured (0≦i≦n−1) and mirrored (n≦i≦2n−1) jitter values σᵢ and from their corresponding write power levels P_{w,i}(0≦i≦2n−1). Ways of calculating such a curve, including curve-fitting techniques, are well known in the state of the art. FIG. 4a shows the measured and mirrored values of the jitter σ (the crosses in FIG. 4a), and the corresponding calculated regression curve (dashed line in FIG. 4a).

From the calculated regression curve it is possible to determine (step C) an initial optimum write power level P_{O,0} where the jitter is minimal. This initial optimum write power level corresponds to the write power level for which dσ/dPw=0. Now:

$${P}_{O , 0} = \frac{- b}{2 \cdot a}$$

The minimum jitter value for the first iteration J₀, determined from the second order regression curve, will, therefore, be

J₀=a·P_{O,0}²+b·P_{O,0}+c

This initial minimum jitter value J₀ is now stored as the initial overall minimum jitter value σₘᵢₙ.

The above procedure (steps A2, B and C) is then iterated in order to find a jitter value that is a predetermined amount Δσ above the overall minimum jitter value σₘᵢₙ determined in the successive iteration steps (step D1). A preferred value for this predetermined amount Δσ is within a range of 0.35% to 0.65%. In this embodiment a value of 0.5% will be used by way of example. However, other values may be used alternatively. It is to be noted that the jitter is expressed relative to mean values of the mark lengths, and therefore in %.

In step D2 the last remaining jitter value of the original measured jitter values (σ₀ . . . σₙ₋₁) is removed before the mirrored jitter values are calculated again for the second and subsequent iterations. Accordingly, each iteration will have two fewer jitter values than the previous iteration (that is, one less measured jitter value and one less mirrored jitter value). The new series of measured and mirrored jitter values are then used to calculate another second-order polynomial regression curve.

The results of the successive iterations are illustrated in FIGS. 4a to 4e. In FIG. 4a the initial minimum jitter value J₀ is shown as 10% at a corresponding write power level P_{O,0} of 195. The initial minimum jitter value J₀ of 10% is now stored as the overall minimum jitter value σₘᵢₙ. In FIG. 4b, showing the results of the second iteration step, the further minimum jitter value J₁ is slightly over 10% at a corresponding further write power level P_{O,1} of 185 and in FIG. 4c, showing the results of the third iteration step, the further minimum jitter value J₂ is 10.2% at a corresponding further write power level P_{O,2} of 175. In the next iteration step (the results of which are shown in FIG. 4d) the further minimum jitter value J₃ is 10.6% (therefore greater than a predetermined amount Δσ of 0.5% over the overall minimum jitter value σₘᵢₙ of 10%) at a corresponding further write power level P_{O,3} of 165.

In the present embodiment the iteration process would now be stopped because the further minimum jitter value (J₃=10.6%) is greater than an overall minimum jitter value σₘᵢₙ by a predetermined amount Δσ or more. However, in a further embodiment an additional check is made to determine if the further minimum jitter value of the next iteration step is also at least a predetermined amount Δσ or more different from the overall minimum jitter value σₘᵢₙ. If this is indeed the case the optimum write power level P_{WO} is calculated in step E. The results of this next iteration is shown in FIG. 4e, where a further minimum jitter value J₄ of 11% occurs at a corresponding further write power level P_{O,4} of 155.

In a subsequent step (step E) the optimum write power level P_{WO} is calculated by a linear interpolation between the further write power level P_{O,M}(P_{O,3}=165) corresponding to the further minimum jitter value Jₘ(J₃=10.6) that is greater than the overall minimum jitter value σₘᵢₙ by a predetermined amount Δσ(0.5%) or more, and the further write power level P_{O,M-1}(P_{O,2}=175) corresponding to the further minimum jitter value J_{M-1}(J₂) determined in the previous iteration, by the following equation:

$${P}_{WO} = {P}_{O , M} + ( \frac{{J}_{M} - ( {σ}_{min} + Δ σ )}{{J}_{M} - {J}_{M - 1}} ) \cdot ( {P}_{O , M - 1} - {P}_{O , M} )$$

Accordingly, for the example shown in FIGS. 4a to 4e, the optimum write power level is 167.5, according to the above equation, as shown below:

$${P}_{WO} = 165 + ( \frac{10.6 - ( 10 + 0.5 )}{10.6 - 10.2} ) \cdot ( 175 - 165 ) = 167.5$$

It is noted that it can be seen from the original measurements illustrated in FIG. 4a that this optimum write power level equates broadly to the first dip in the jitter values.

FIG. 5 illustrates a power controller 2 embodying the present invention, in use in a recordable optical system. The power controller 2 serves to control the write power level of a laser device 4. As is well known, the laser device 4 is used to write data on an optical medium by radiating a focused laser beam onto said optical medium. A jitter measurement device 6 is provided to measure jitter values of the recorded marks for the different write power levels P_{w,i} used during the test writing procedure used for Optimum Power Calibration (OPC). To transfer data, the power controller 2 is also connected with a storage device 8.

In use, the power controller is operable to cause the laser device 4 to write a series of test marks at a range of write power levels (P_{w,0} . . . P_{w,n-1}), the write power levels preferably being spaced apart from one another by a fixed predetermined power level step ΔP_{w}. The jitter measurement device 6 then operates to measure the jitter values (σ₀ . . . σₙ₋₁) of these series of test marks corresponding to the different write powers levels (P_{w,0} . . . P_{w,n-1}) used during the initial test writing procedure. The jitter values are then supplied to the power controller 2 for further processing. In accordance with the method described above, the power controller generates a second set of jitter values (σn . . . σ2ₙ₋₁) from the first set of measured jitter values (σ₀ . . . σₙ₋₁). The second set of jitter values mirror the measured values with respect to the power level. The measured and calculated jitter values form an even number of jitter values, effectively divided into first and second distinct non-overlapping sets. The power controller 2 is then operable to generate a second order curve that fits the measured and calculated jitter values, as described above. The power controller then determines the initial minimum jitter value and the corresponding write power level, and stores the results in the storage device 8. The power controller 2 then iterates the above steps, using fewer measured jitter values for each subsequent iteration, in order to arrive at a jitter value that is greater than an overall minimum jitter value σₘᵢₙ by a predetermined amount Δσ or more. The values stored in the storage device 8 are updated during each iteration step when applicable. Finally, the power controller 2 is operable to determine the optimum write power level P_{WO} from the further write power level P_{O,M} corresponding to the jitter value J_{M} that is greater than the overall minimum jitter value σₘᵢₙ by a predetermined amount Δσ or more.

This power controller 2 may be implemented by means of hardware comprising several distinct elements, and/or by means of a suitably programmed processor. The above-described functions of the power controller 2 may be implemented by distinct items of hardware, or several functions may be embodied by one and the same item of hardware.

Accordingly, a power controller embodying an aspect of the present invention can implement the method according to an aspect of the invention, and can provide effective write power level control for a recordable optical system. Another aspect of the present invention provides such a system that includes such a power controller.

It is an additional advantage of embodiments of the present invention that only a limited number of relatively low write power level measurements are used in the OPC method. This is favorable (?) since the use of increasing write power levels can adversely affect the ability of a rewritable optical medium to be overwritten. Typically, it is desirable for such a rewritable medium to be able to handle a minimum number of overwrite processes, that is a minimum number of times that data on the medium can be overwritten. A parameter quantifying the minimum number of times that data on the medium can be overwritten is known as the Direct OverWrite (DOW) factor. For example, a ReWritable medium comprising a phase change layer might have a DOW factor of 500. For a given medium, the DOW factor typically decreases with increasing write power levels. Accordingly, using higher write power levels in order simply to decrease jitter, or to provide an increased number of jitter value measurement for the OPC method, would reduce the DOW factor for the medium concerned. It is therefore necessary to balance the conflicting requirements of high DOW factor, low jitter values and accurate OPC method. Accordingly, embodiments of the present invention provide a technique that seeks to generate an optimum write power level that is both low enough for a high DOW factor, high enough for desirably low jitter values of the recorded marks, and which is determined by a technique which itself does not reduce the DOW factor of the medium.

1. A method for determining an optimal write power level (P_{WO}) in a recordable optical storage system, the method comprising the steps of:
a) generating a first even number of jitter values (σ₀ . . . σ₂ₙ₋₁) corresponding to respective ones of a plurality of write power levels (P_{w,0} . . . P_{w,2n-1}), which write power levels are arranged in equal first (P_{w,0} . . . P_{w,n-1}) and second (P_{w,n} . . . P_{w,2n-1}) non-overlapping series of write power levels, jitter values (σ₀ . . . σₙ₋₁) corresponding to the first series of write power levels being generated from measurement of jitter values resulting from respective write processes at the write power levels concerned, and
jitter values (σₙ . . . σ₂ₙ₋₁) corresponding to the second series of write power levels being derived from the jitter values corresponding to the first series, such that the jitter values corresponding to the second series mirror the jitter values corresponding to the first series with respect to the write power level;
b) generating curve data from the first and second series of jitter values and corresponding write power levels;
c) determining an initial minimum jitter value (J₀) and corresponding write power level (P_{O,0}) from the generated curve data;
d) iterating steps a) to c) to determine a further minimum jitter value (Jᵢ) and corresponding further write power level (P_{O,i}) for each iteration, each iteration having one less jitter value in each series than the previous iteration, the iteration being carried out until the further minimum jitter value determined in the iteration is greater than an overall minimum jitter value (σₘᵢₙ) by a predetermined amount (Δσ) or more, the overall minimum jitter value being the minimum value of the initial minimum jitter value and the further minimum jitter values determined in the previous iterations; and of
e) determining the optimum write power level (P_{WO}) from the further write power level (P_{O,M}) corresponding to the further minimum jitter value (J_{M}) that is greater than the overall minimum jitter value (σₘᵢₙ) by a predetermined amount (Δσ) or more.

2. A method according to claim 1, wherein the curve data generated from the first and second series of jitter values and corresponding write power levels form a second order polynomial curve.

3. A method according to claim 1, wherein the write power levels (P_{w}) are spaced from one another by a predetermined power level step (ΔP_{w}).

4. A method according to claim 1, further comprising
a step of storing the initial minimum jitter value (J₀) as the overall minimum jitter value (σₘᵢₙ), and a step, in each iteration, of updating the stored overall minimum jitter value when the further minimum jitter value (Jᵢ) is lower that the stored overall minimum jitter.

5. A method according to claim 1, wherein in step e) the optimum write power level (P_{WO}) is determined from
the further write power level (P_{O,M}) corresponding to the further minimum jitter value (Jₘ) that is greater than the overall minimum jitter value (σₘᵢₙ) by a predetermined amount (Δσ) or more, and the further write power level (P_{O,M-1}) corresponding to the further minimum jitter value (J_{M-1}) determined in the previous iteration.

6. A method according to claim 5, wherein the optimum write power level (P_{WO}) is determined by a linear interpolation according to the following equation:
$${P}_{WO} = {P}_{O , M} + ( \frac{{J}_{M} - ( {σ}_{min} + Δ σ )}{{J}_{M} - {J}_{M - 1}} ) \cdot ( {P}_{O , M - 1} - {P}_{O , M} )$$
where P_{WO} is the optimum write power level, Jₘ is the further minimum jitter value that is greater than the overall minimum jitter value (σₘᵢₙ) by a predetermined amount (Δσ) or more and P_{O,M} is the corresponding further write power level, J_{M-1} is the further minimum jitter value determined in the previous iteration and P_{O,M-1} is the corresponding further write power level, σₘᵢₙ is the overall minimum jitter value, and Δσ is the predetermined amount.

7. A method according to claim 1, wherein the optimum write power level (P_{WO}) balances low jitter values with high direct overwrite factors.

8. A power controller for use in a recordable optical storage system, the controller being operable to:
a) generate a first even number of jitter values (σ₀ . . . σ₂ₙ₋₁) corresponding to respective ones of a plurality of write power levels (P_{w,0} . . . P_{w,2n-1}), which write power levels are arranged in equal first (P_{w,0} . . . P_{w,n-1}) and second (P_{w,n} . . . P_{w,2n-1}) non-overlapping series of write power levels, jitter values (σ₀ . . . σₙ₋₁) corresponding to the first series of write power levels being generated from measurement of jitter values resulting from respective write processes at the write power levels concerned, and
jitter values (σₙ . . . σ₂ₙ₋₁) corresponding to the second series of write power levels being derived from the jitter values corresponding to the first series, such that the jitter values corresponding to the second series mirror the jitter values corresponding to the first series with respect to the write power level;
b) generate curve data from the first and second series of jitter values and corresponding write power levels;
c) determine an initial minimum jitter value (J₀) and corresponding write power level (P_{O,0}) from the generated curve data;
d) iterate steps a) to c) to determine a further minimum jitter value (Jᵢ) and corresponding further write power level (P_{O,i}) for each iteration, each iteration having one less jitter value in each series than the previous iteration, the iteration being carried out until the further minimum jitter value determined in the iteration is greater than an overall minimum jitter value (σₘᵢₙ) by a predetermined amount (Δσ) or more, the overall minimum jitter value being the minimum value of the initial minimum jitter value and the further minimum jitter values determined in the previous iterations; and to
e) determine the optimum write power level (P_{WO}) from
the further write power level (P_{O,M}) corresponding to the further minimum jitter value (J_{M}) that is greater than the overall minimum jitter value (σₘᵢₙ) by a predetermined amount (Δσ) or more.

9. A power controller according to claim 8, operable to generate, from the first and second series of jitter values and corresponding write power levels, curve data forming a second order polynomial curve.

10. A power controller according to claim 8, comprising or connected to storage means (8) for storing the overall minimum jitter value, and
operable to store the initial minimum jitter value (J₀) as the overall minimum jitter value (σₘᵢₙ) in said storage means, and to, in each iteration, update the stored overall minimum jitter value when the further minimum jitter value (Jᵢ) is lower that the stored overall minimum jitter value.

11. A power controller according to claim 8, operable to determine the optimum write power level (P_{WO}) from
the further write power level (P_{O,M}) corresponding to the further minimum jitter value (J_{M}) that is greater than the overall minimum jitter value (σₘᵢₙ) by a predetermined amount (Δσ) or more, and the further write power level (P_{O,M-1}) corresponding to the further minimum jitter value (J_{M-1}) determined in the previous iteration.

12. A power controller according to claim 11, operable to determine the optimum write power level (P_{WO}) in a linear interpolation according to the following equation:
$${P}_{WO} = {P}_{O , M} + ( \frac{{J}_{M} - ( {σ}_{min} + Δσ )}{{J}_{M} - {J}_{M - 1}} ) \cdot ( {P}_{O , M - 1} - {P}_{O , M} )$$
where P_{WO} is the optimum write power level, Jₘ is the further minimum jitter value that is greater than the overall minimum jitter value (σₘᵢₙ) by a predetermined amount (Δσ) or more and P_{O,M} is the corresponding further write power level, J_{M-1} is the further minimum jitter value determined in the previous iteration and P_{O,M-1} is the corresponding further write power level, σₘᵢₙ is the overall minimum jitter value, and Δσ is the predetermined amount.

13. A recordable optical storage system comprising a power controller as claimed in claim 8.
